(19) United States
(12) Patent Application Publication
(10) Pub. No.: US 2023/0148783 A1
(43) Pub. Date: May 18, 2023

(54) COFFEE FILTER CUP

(71) Applicant: Ningbo Tier Outdoor Technology Co., Ltd., Ningbo (CN)

(72) Inventor: Anzhi WANG, Ningbo (CN)

(21) Appl. No.: 17/987,235

(22) Filed: Nov. 15, 2022

(30) Foreign Application Priority Data
Nov. 17, 2021 (CN) 2021228557401

(51) Int. Cl. A47J 31/02; A47J 31/06

(52) U.S. Cl. CPC A47J 31/02; A47J 31/0626

(57) ABSTRACT

A coffee filter cup includes a base and a foldable cup body, the foldable cup body is arranged on the base, the base is provided with a mounting hole for the foldable cup body to penetrate through, and a bottom of the foldable cup body is provided with a discharge opening; a first crease groove is arranged at a connection position between the lower cup body and the upper cup body, the first crease groove extends along a circumferential direction of the lower cup body, and the lower cup body is capable of being folded towards an inside of the upper cup body through the first crease groove to form a support table. The coffee filter cup can be matched with cone-shaped filter paper and cake filter paper to prepare pour-over coffee with different extraction flavors, so that convenience is brought to coffee lovers.

### TECHNICAL FIELD

The present disclosure relates to the field of pour-over coffee, and more particularly to a coffee filter cup.

### BACKGROUND

With the improvement of the quality of life, pour-over coffee has become a high-end drink favored by more and more people. When making pour-over coffee, a filter cup is generally required. The filter cup is disposed on a coffee pot or a coffee cup, a piece of filter paper is laid in the filter cup, and the filter paper is supported by the filter cup. Coffee powder is poured into the filter cup, hot water is added for brewing and extraction, and the prepared coffee is filtered by the filter paper and flows into the coffee pot or the coffee cup for coffee lovers to drink.

Common filter cups for pour-over coffee include V60 filter cups, cake filter cups (also referred to as Kalita wave dripper), etc. The filter paper for pour-over coffee includes conical filter paper and cake filter paper (also referred to as Kalita wave filter paper). The conical filter paper is laid in a quarter circle shape, its opening angle is 60 degrees, and the conical filter paper is used together with the V60 filter cup. A bottom of the cake filter paper is flat, the cake filter paper is surrounded by wavy folds, corresponding to use with the cake filter cup. Under filtration of different filter paper, the degree of coffee extraction is different, and the taste and flavor are also different.

In view of the above related art, the inventor believes that in order to taste pour-over coffee with different extraction flavors, coffee lovers need to have both the V60 filter cup and the cake filter paper to support different filter papers to make pour-over coffee, which not only occupies the space for placing utensils, but also is inconvenient to carry out.

### SUMMARY

The present disclosure provides a coffee filter cup, in order to enable coffee lovers to make pour-over coffee with different extraction flavors by using one filter cup matched with the conical filter paper and the cake filter paper.

The coffee filter cup provided by the present disclosure adopts the following technical solutions.

A coffee filter cup includes: a base and a foldable cup body, wherein the foldable cup body is disposed on the base, the base is provided with a mounting hole for the foldable cup body to penetrate through, and a bottom of the foldable cup body is provided with a discharge opening; the foldable cup body includes an upper cup body and a lower cup body which are sequentially connected; a first crease groove is provided on a connection position between the lower cup body and the upper cup body, the first crease groove extends along a circumferential direction of the lower cup body, and the lower cup body is capable of being folded towards an inside of the upper cup body through the first creases groove to form a support table.

By adopting the above technical solution, the foldable cup body is disposed on the base, and the base plays a role in supporting the foldable cup body; the discharge opening is suitable for discharge coffee liquid brewed and extracted in the foldable cup body into a container such as a coffee pot or a coffee cup; the upper cup body and the lower cup body are sequentially connected, and are suitable for placing the conical filter paper to extract coffee; the first crease groove is arranged to ensure that a thickness of the connection position between the lower cup body and the upper cup body is less than a thickness of the foldable cup body at two opposite sides outside the first crease groove, so that the deformation resistance of the foldable cup body at the first crease groove is less than the deformation resistance of the foldable cup body at two opposite sides outside the first crease groove, and the lower cup body can be conveniently folded from the first creasing groove into the upper cup body; the lower cup body is folded into the upper cup body to form the support table in the upper cup body, and the support table plays a role in supporting the flat bottom of the cake filter paper, which is suitable for putting the cake filter paper to extract coffee.

Therefore, when the coffee filter cup is unfolded, the conical filter paper is suitable for being put into the coffee filter cup to extract and filter coffee, and when the lower cup body of the coffee filter cup is folded inwards to form the support table, the cake filter paper is suitable for being put into the cake filter cup to extract and filter coffee, so that the effect that pour-over coffee with different extraction flavors are made by only using one kind of coffee filter cup in combination with the conical filter paper and the cake filter paper is realized.

Preferably, the upper cup body is provided with a protruding ring, and the protruding ring passes through the mounting hole and is positioned at the bottom of the base.

By adopting the above technical solution, the protruding ring passes through the mounting hole and is limited at the bottom of the base, so that the foldable cup body is snapped and fastened with the base, and the foldable cup body is not easy to fall off from the base.

Preferably, a bottom of the upper cup body and/or a top of the lower cup body are/is provided with at least one liquid drainage hole.

By adopting the above technical solution, the liquid drainage hole is suitable for discharging the coffee accumulated between the support table and the inner wall of the upper cup body when the lower cup body is folded upwards, thereby reducing the influence of the accumulated coffee on the coffee taste.

Preferably, the upper cup body is provided with at least two second crease grooves, and each of the at least two second crease grooves extends along a circumferential direction of the upper cup body.

By adopting the above technical solution, the second crease groove is defined to enable a thickness of the upper cup body at the second crease groove to be less than that of the upper cup body at two opposite sides outside the second creases groove, so that the deformation resistance of the foldable cup body at the second crease groove is smaller than that of the upper cup body at two opposite sides outside the second crease groove, and the upper cup body can be conveniently folded from the second crease groove to the inside or outside of the upper cup body, thus the upper cup body can be folded and contracted, which is convenient for users to carry.

Preferably, an inner wall of the foldable cup body is provided with a plurality of ribs at intervals.

By adopting the above technical solution, the arrangement of the ribs is favorable for guiding hot water for brewing, and the ribs support the filter paper, so that a gap is defined between the filter paper and the inner wall of the foldable cup body, and gas in the coffee powder is conveniently discharged.

Preferably, a top of the upper cup body is provided with a reinforcing ring.

By adopting the above technical solution, the reinforcing ring is beneficial to maintaining a relatively stable cup body shape when the foldable cup body is unfolded, and the probability of spilling hot water or coffee liquid caused by excessive deformation of the foldable cup body is reduced.

Preferably, a bottom surface of the base is uniformly provided with at least two limiting blocks, and the limiting blocks are configured (i.e., structured and arranged) to be inserted into a coffee pot and/or a coffee cup.

By adopting the above technical solution, the limiting blocks are insert into the coffee pot and/or the coffee cup to limit the base, and the base is not easy to slide out of the coffee pot and/or the coffee cup to cause the coffee liquid in the foldable cup body to spill.

Preferably, the base includes a positioning ring, a support ring and a plurality of connecting strips; the support ring is disposed on an inside of the positioning ring; the connecting strips are arranged at intervals and connected between the support ring and the positioning ring; and the positioning ring is positioned at an opening of the coffee pot and/or an opening of the coffee cup; the mounting hole is provided on the support ring, and the limiting blocks are disposed on the bottoms of the connecting strips.

by adopting the above technical solution, the opening of the coffee pot and/or the opening of the coffee cup support the positioning ring, the connecting strips are arranged at interval and connected between the support ring and the positioning ring, and the positioning ring supports the support ring through the connecting strips; the support ring supports the foldable cup body in a snap-fitting manner through the mounting hole; and the limiting blocks are arranged at the bottoms of the connecting strips, and the base is limited by limiting the connecting strips.

Preferably, a connection position between the connecting strip and the support ring is located above a connection position between the connecting strip and the positioning ring.

By adopting the above technical solution, the support ring is disposed at the inside of the positioning ring, the connection position between the connecting strip and the support ring is disposed at the inside of the connection position between the connecting strip and the positioning ring, and the connecting strip is obliquely arranged between the support ring and the positioning ring; when the upper cup body is folded outward along the second crease groove, the outside wall of the upper cup body is attached to the upper side wall of the connecting strip, so that the coffee filter cup can be conveniently folded and accommodated, and meanwhile, the upper cup body can be continuously folded and accommodated along another second crease groove.

Preferably, the base is provided with a handle.

By adopting the above technical solution, when the pour-over coffee is extract, coffee liquid or condensed water is inevitably adhered to the base or the foldable cup body, and the arrangement of the handle enables coffee lovers to take and put the coffee filter cup on the coffee pot and/or the coffee cup more conveniently, cleanly and hygienically.

In summary, the present disclosure includes at least one of the following beneficial technical effects:

1. The lower cup body of the present disclosure is suitable for being folded into the upper cup body along the first crease groove, and the support table is formed in the upper cup body and can support the flat bottom of the cake filter paper, which is convenient for coffee lovers to use;

2. The upper cup body of the present disclosure can be folded towards the inside or the outside of the upper cup body through the second crease groove, thereby reducing the space occupied by the storage of the coffee filter cup and being convenient for coffee lovers to carry when going out;

3. The upper side wall of the connecting strip of the present disclosure is an inclined surface, and when the upper cup body is folded outwards through the second crease groove, the outside wall of the upper cup body is attached to the upper side wall of the connecting strip, thereby facilitating the folding and storage of the coffee filter cup.

### BRIEF DESCRIPTION OF DRAWINGS

FIG. 1 is an overall schematic diagram according to embodiments of the present disclosure.

FIG. 2 is a schematic diagram of unfolding a foldable cup body according to embodiments of the present disclosure.

FIG. 3 is a schematic diagram of a lower cup body after being folded of a first embodiment according to embodiments of the present disclosure.

FIG. 4 is a schematic diagram of an upper cup body after being folded according to embodiments of the present disclosure.

FIG. 5 is a schematic diagram of a base according to embodiments of the present disclosure.

FIG. 6 is a schematic diagram of a coffee filter cup after being folded according to embodiments of the present disclosure.

FIG. 7 is a schematic diagram of unfolding a foldable cup body of a second embodiment according to embodiments of the present disclosure.

FIG. 8 is a schematic diagram of a lower cup body after being folded of the second embodiment according to embodiments of the present disclosure.

FIG. 9 is a schematic diagram of mounting a handle of a third embodiment according to embodiments of the present disclosure.

FIG. 10 is a schematic diagram of ribs with spiral shapes according to embodiments of the present disclosure.

Description of reference numerals:

1 - base; 11 - positioning ring; 12 - support ring. 121 - mounting hole; 13 -connecting strip; 131 - limiting block; 132 - guide surface; 14 - handle; 2 - foldable cup body; 21 - upper cup body; 211 - feed opening; 212 - second crease groove; 213 - first upper cup ring; 214 - second upper cup ring; 215 - third upper cup ring; 216 - reinforcing ring; 22 - lower cup body; 221 - discharge opening; 222 - first crease groove; 223 - support table; 224 - protruding ring; 225 - liquid accumulation groove; 226 - liquid drainage hole; 227 - support piece; 23 - rib.

### DETAILED DESCRIPTION OF EMBODIMENTS

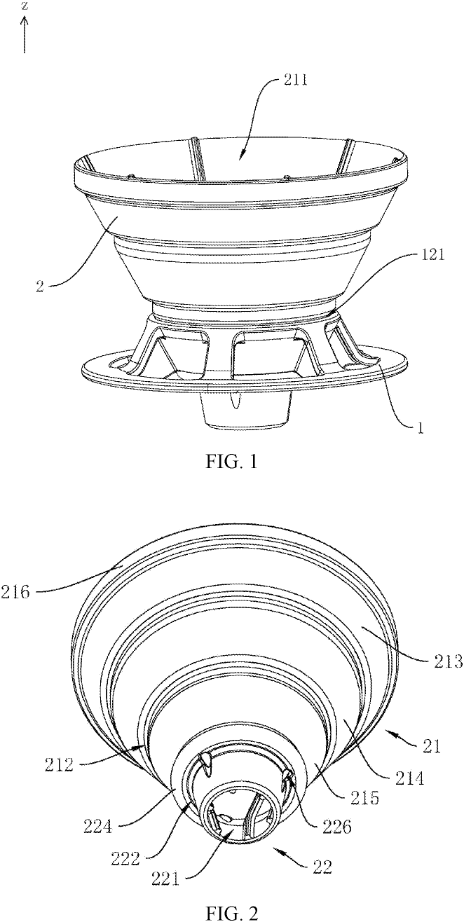

In order to make purposes, technical solutions, and advantages of the present disclosure clearer, the present disclosure is further described in detail below with reference to FIGS. 1-9 and the embodiments. The attached drawings of the present disclosure is provided with a coordinate axis z, where a forward direction of the z axis represents a top, and a reverse direction of the z axis represents a bottom.

An embodiment of the present disclosure discloses a coffee filter cup. Referring to FIG. 1, a base 1 and a foldable cup body 2 are included.

The base 1 is provided with a mounting hole 121, the foldable cup body 2 is adapted to penetrate through the mounting hole 121, so that the foldable cup body 2 is connected to the base 1, and the base 1 plays a role in supporting the foldable cup body 2. The foldable cup body 2 can be integrally formed with the base 1 by means of injection molding, or the foldable cup body 2 can be directly inserted into the mounting hole 121 of the base 1 for fixation, or the foldable cup body 2 can be further fixed to the base 1 by a snap-fitting manner. In this embodiment, after the foldable cup body 2 penetrates through the mounting hole 121, the foldable cup body 2 is snapped with the base 1, so that the base 1 and the foldable cup body 2 can be relatively fixed during use, a better supporting effect is provided for filter paper, and the base 1 and the foldable cup body 2 can be split during cleaning or storage, so that the coffee filter cup is convenient to clean and store.

The base 1 is made of a rigid material such as plastic, stainless steel or ceramic, or the base is made of a flexible material made of a hard material such as rubber and silicone. In the embodiment, the base is specifically made of plastic to reduce the overall weight of the coffee filter cup, which is convenient for a user to carry out. Since the foldable cup body 2 needs to be folded, the foldable cup body 2 can be made of non-toxic and high-temperature-resistant flexible elastic material such as silicone, latex and the like, and the foldable cup body 2 is specifically made of the silicone, so that the foldable cup body 2 has a certain hardness so as to maintain the shape of the foldable cup body 2 conveniently, thereby facilitating containing hot water to achieve extraction of coffee.

Referring to FIG. 2, the foldable cup body 2 is a cylinder body which runs through from top to bottom, cross sectional areas of the foldable cup body 2 are gradually reduced from top to bottom, an appearance of the foldable cup body 2 is in an inverted round table shape, and the foldable cup body 2 is suitable for placing the conical filter paper. The foldable cup body 2 includes an upper cup body 21 and a lower cup body 22 which are integrally formed, and the lower cup body 22 is adapted to form a support table 223 inside the upper cup body 21 by folding, so as to support the cake filter paper with the flat bottom. A top opening of the upper cup body 21 defines a feed opening 211 of the foldable cup body 2, which facilitates the sequential addition of the coffee powder and hot water for coffee extraction after the filter paper is placed. A bottom opening of the lower cup body 22 defines a discharge opening 221 of the foldable cup body 2, and coffee liquid extracted from the foldable cup body 2 is discharged into the coffee pot or the coffee cup through the discharge opening 221.

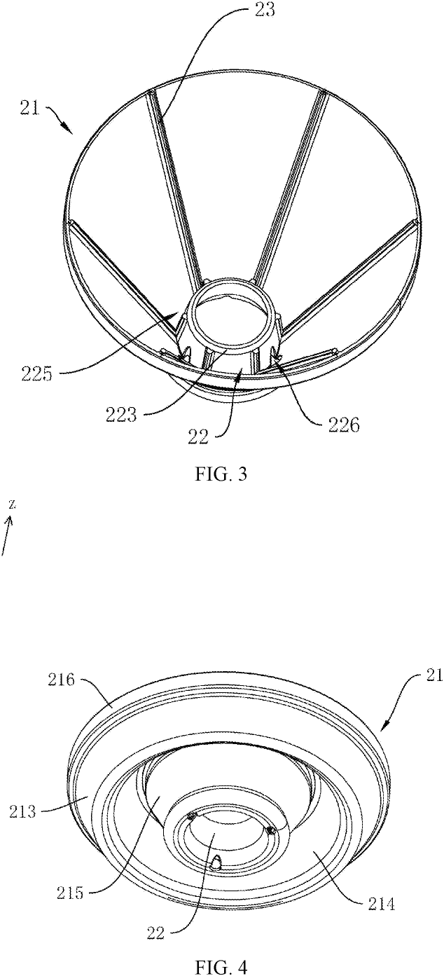

Referring to FIG. 2 and FIG. 3, a first embodiment of the present disclosure is that: a first crease groove 222 is provided at a connection position between the lower cup body 22 and the upper cup body 21 along a circumferential direction of the lower cup body 22, and the first crease groove 222 may be composed of a plurality of spaced arc-shaped grooves, or may be a complete annular groove. In the embodiment, the first crease groove 222 is specifically shown in the annular groove structure. A wall thickness of the foldable cup body 2 at the first crease groove 222 is smaller than a wall thickness of the foldable cup body 2 at two opposite sides outside the first crease groove 222, so that the anti-deformation capability (i.e., deformation resistance) of the foldable cup body 2 at the first crease groove 222 is smaller than the anti-deformation capability of the foldable cup body 2 at the two opposite sides outside the first crease groove 222, and when the lower cup body 22 is folded, the first crease groove 222 is deformed at first, the lower cup body 22 is easily folded into the upper cup body 21 from the first crease groove 222 and forms a support table 223 for supporting the cake filter paper with the flat bottom, at this time, the discharge opening 221 is located below the cake filter paper, and the extracted coffee liquid is discharged from the discharge opening 221 into the coffee pot or the coffee cup. Here, the first crease groove 222 may be disposed on an outside of the connection position between the lower cup body 22 and the upper cup body 21, or may be disposed on the inside of the connection position between the lower cup body 22 and the upper cup body 21. In this embodiment, the first crease groove 222 is disposed on the outside of the connection position between the lower cup body 22 and the upper cup body 21 to facilitate cleaning.

In addition, a protruding ring 224 is provided on the outside wall of the bottom of the upper cup body 21, and when the foldable cup body 2 is snapped with the base 1, the protruding ring 224 passes through the mounting hole 121 and is limited to the bottom of the base 1, so that the foldable cup body 2 is fastened to the base 1, and the foldable cup body 2 is not easily disengaged from the base 1. The protruding ring 224 may be integrally formed with the foldable cup body 2, may be bonded with the foldable cup body 2, or may be hot-melted with the foldable cup body 2. In the embodiment, the protruding ring 224 is specifically integrated with the foldable cup body 2 to reduce toxicological hazards caused by adhesive use.

After the lower cup body 22 is folded in the upper cup body 21, a liquid accumulation groove 225 is defined between the lower cup body 22 and the upper cup body 21, so that at least one liquid drainage hole 226 can be defined in the upper cup body 21 and/or the lower cup body 22 located at the liquid accumulation groove 225, so that residual coffee accumulated in the liquid accumulation groove 225 can be discharged from the liquid drainage hole 226, and the sanitation problem and the taste influence caused by residual coffee in the liquid accumulation groove 225 are reduced. In the embodiment of the present disclosure, the liquid drainage hole 226 may be specifically disposed at the bottom of the upper cup body 21 and/or the top of the lower cup body 22, and the number of the liquid drainage hole 226 may be adjusted according to requirements. In the drawings of the embodiment, three of the liquid drainage holes 226 are uniformly provided at the top of the lower cup body 22.

Referring to FIG. 4, the upper cup body 21 is provided with at least two second crease grooves 212 extending along a circumferential direction of the upper cup body 21, the second crease groove 212 may be formed by a plurality of spaced arc-shaped grooves, or may be a complete annular groove. In the embodiment, the second crease groove 212 is specifically shown in the annular groove structure. The second crease groove 212 is disposed on the outside of the upper cup body 21 or is disposed on the inside of the upper cup body 21, and the second crease groove 212 in this embodiment is formed on the outside of the upper cup body 21 to facilitate cleaning. Due to setting the second crease groove 212, a thickness of the upper cup body 21 at the second crease groove 212 is smaller than that of the upper cup body 21 at two opposite sides outside the second crease groove 212, so that the anti-deformation capability of the upper cup body 21 at the second crease groove 212 is smaller than that of the upper cup body 21 at two opposite sides outside the second crease groove 212; when the upper cup body 21 is folded, a portion of the upper cup body 21 at the second crease groove 212 is bent and deformed prior to a portion of the upper cup body 21 outside the second crease groove 212, so that the upper cup body 21 is convenient to be folded along the second crease groove 212.

The number of the second crease grooves 212 in this embodiment is at least two, so that the upper cup body 21 can be folded for at least two times to facilitate storage, but the actual number of the second crease grooves 212 can be set according to the size of the upper cup body 21. The two second crease grooves 212 are sequentially arranged up and down on the side wall of the upper cup body 21 to divide the upper cup body 21 into a first upper cup ring 213, a second upper cup ring 214 and a third upper cup ring 215 which are sequentially connected from top to bottom. When the coffee filter cup needs to be folded, the user folds the second upper cup ring 214 outward by taking the second crease groove 212 at a lower portion of the upper cup body 21 as a folding line, and folds the first upper cup ring 213 inward by taking the second crease groove 212 at a upper portion of the upper cup body 21 as another folding line, so that the first upper cup ring 213, the second upper cup ring 214 and the third upper cup ring 215 are sequentially sleeved from outside to inside, thereby completing the folding and contraction of the upper cup body 21, saving the occupied space, and facilitating the user to carry. After the second upper cup ring 214 is folded, the second upper cup ring 214 is attached to the base 1, and the first upper cup ring 213 can also be attached to the surface of the base 1, thereby reducing the space commonly occupied by the base 1 and the coffee filter cup, and facilitating the user to carry.

In addition, in some embodiments, a plurality of ribs 23 are disposed on the inner wall of the foldable cup body 2 at intervals, and the ribs 23 extend from top to bottom on the inner wall of the foldable cup body 2, which can not only drain the injected hot water, but also support the filter paper on the inner wall of the foldable cup body 2, so as to facilitate the discharge of gas when extracting coffee. The ribs 23 can be integrally formed with the foldable cup body 2, can be connected to the inside of the foldable cup body 2 in a hot melting manner, or can be adhered to the inside of the foldable cup body 2. In order to reduce the trouble of multiple times of mold opening, in this embodiment, the ribs 23 and the foldable cup body 2 are integrally formed. In addition, the shape of the rib 23 is diversified, which may be linear or spiral. In an embodiment, as shown in FIG. 8, the rib 23 is specifically shown in the linear shape. In another embodiment, as shown in FIG. 10, the rib 23 is shown in the spiral shape; Moreover, the numbers of the ribs 23 corresponding to different positions of the foldable cup body 2 are different, in some embodiments, as shown in FIG. 10, the number of ribs 23 corresponding to the first upper cup ring 213 is greater than that of ribs 23 corresponding to the second upper cup ring 214 and the third upper cup ring 215; for example, the rib 23 is spiral, the number of ribs 23 corresponding to the first upper cup ring 211 is 24, the number of ribs 23 corresponding to the second upper cup ring 214 and the third upper cup ring 215 is 12.

The top of the upper cup body 21 is further connected with a reinforcing ring 216, a thickness of the reinforcing ring 216 is larger than the wall thickness of other portions of the foldable cup body 2, the relatively stable cup body shape is maintained when the foldable cup body 2 is unfolded, and the probability that hot water or coffee liquid is spilled due to excessive deformation of the cup body is reduced. The reinforcing ring 216 may be integrally formed with the upper cup body 21, or may be glued to the inside or the outside of the upper cup body 21, and in this embodiment, the reinforcing ring 216 and the upper cup body 21 are integrally formed and extend out of the outside of the upper cup body 21.

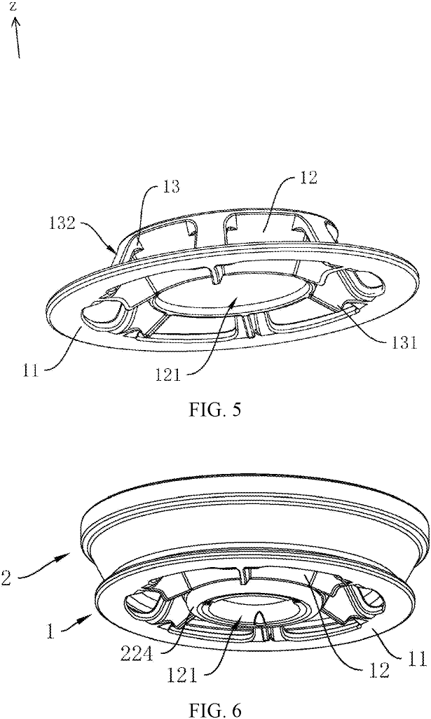

Referring to FIG. 5 and FIG. 6, the base 1 includes a positioning ring 11, a support ring 12 and a plurality of connecting strips 13. The support ring 12 is located on the inside of the positioning ring 11, and the connecting strips 13 are spaced apart and connected between the support ring 12 and the positioning ring 11. A size and shape of the positioning ring 11 can be adjusted according to design requirements, and specifically, the positioning ring 11 is adapted to be placed on an opening of the coffee pot and/or an opening of the coffee cup to support the coffee filter cup as a reference.

The mounting hole 121 is disposed on the support ring 12, and the mounting hole 121 in this embodiment is specifically the inner circle of the support ring 12. The foldable cup body 2 is mounted in the support ring 12 in a penetrating manner, and the protruding ring 224 abuts against the bottom of the support ring 12 to achieve snap-fitting between the support ring 12 and the foldable cup body 2.

In addition, at least two limiting blocks 131 are uniformly arranged at the bottoms of the connecting strips 13, and when the positioning ring 11 is placed on the opening of the coffee pot and/or the opening of the coffee cup, the limiting blocks 131 are inserted into the coffee pot and/or the coffee cup to limit the base 1, so that the base 1 is not easy to slide off from the coffee pot and/or the coffee cup to cause the coffee liquid in the foldable cup body 2 to be spilled out. The limiting blocks 131 can be integrally formed with the connecting strips 13 and can also be adhered to the connecting strips 13, and in this embodiment, the limiting blocks 131 and the connecting strips 13 are integrally manufactured to save costs such as mold opening and adhesive use.

The connection position between the connecting strip 13 and the support ring 12 is located above the connection position between the connecting strip 13 and the positioning ring 11, and since the support ring 12 is located inside the positioning ring 11, the guide surface 132 is defined on the connecting strip 13. When the second upper cup ring 214 is folded to the outside of the second upper cup ring 214, the outside wall of the second cup ring 214 is attached to the upper side wall of the connecting strip 13, and the second crease groove 212 at the upper portion of the upper cup body 21 corresponds to the connection position between the connecting strip 13 and the positioning ring 11, which is beneficial to folding and storing the coffee filter cup. At the same time, it is also beneficial for the upper cup body 21 to continue folding along another second crease groove 212.

An application principle of the first embodiment of the coffee filter cup according to embodiments of the present disclosure is as follows:

When the coffee is extracted and filtered by using the conical filter paper, the foldable cup body 2 is snapped with the base 1, the upper cup body 21 and the lower cup body 22 are unfolded and kept in their original shapes, the base 1 is placed on the coffee pot and/or the coffee cup, and the limiting blocks 131 are inserted into the coffee pot and/or the coffee cup. The conical filter paper is opened and placed in the foldable cup body 2 and is in contact with the inner wall of the foldable cup body 2. The coffee powder is placed into the conical filter paper and hot water is added, and the extracted coffee liquid is discharged from the foldable cup body 2 through the discharge opening 221 and flows into the coffee pot and/or the coffee cup for coffee enthusiasts to drink; and the filtered coffee residues are left on the conical filter paper and discarded along with the conical filter paper.

When the cake filter paper is used for extracting and filtering coffee, the foldable cup body 2 is snapped with the base 1, the base 1 is placed on the coffee pot and/or the coffee cup, and the limiting blocks 131 are inserted into the coffee pot and/or the coffee cup. The lower cup body 22 is folded towards the inside of the lower cup body 22 along the first crease groove 222, so that the bottom of the lower cup body 22 forms the support table 223 in the upper cup body 21, the cake filter paper with the flat bottom is placed in the foldable cup body 2 and is contact with the inner wall of the foldable cup body 2, and the support table 223 supports the bottom of the cake filter paper. The coffee powder is placed into the cake filter paper and hot water is added, and the extracted coffee liquid is discharged from the foldable cup body 2 through the discharge opening 221 and the liquid drainage holes 226 and flows into the coffee pot and/or the coffee cup for coffee lovers to drink; and the filtered coffee residues are left on the cake filter paper and discarded along with the cake filter paper.

When the coffee filter cup needs to be folded and stored, the second upper cup ring 214 is folded towards the outside of the second upper cup ring 214 along the second crease groove 212 at the lower portion of the upper cup body 21, the second upper cup ring 214 is attached to the upper side wall of the connecting strip 13, and then the first upper cup ring 213 is folded towards the inside of the first upper cup ring 213 along the second crease groove 212 on the upper portion of the upper cup body 21 or the first upper cup ring 213 is attached to the surface of the positioning ring 11, that is, the coffee filter cup is folded and stored.

A second embodiment of the present disclosure differs from the first embodiment in that:

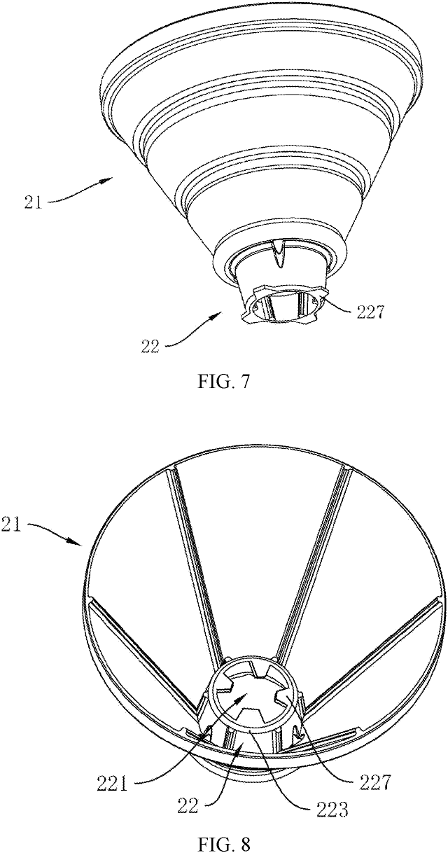

Referring to FIGS. 7 and 8, the outside of the bottom of the lower cup body 22 is provided with at least one support piece 227, and the support pieces 227 are arranged at intervals along the periphery of the lower cup body 22. When the lower cup body 22 is folded towards the inside of the lower cup body 22 along the first crease groove 222, the bottom of the lower cup body 22 forms a support table 223 in the upper cup body 21, and the support piece 227 is located in the support table 223. When the support table 223 supports the bottom of the cake filter paper, the support piece 227 can effectively support the bottom of the cake filter paper, so as to prevent the cake filter paper from being damaged at this time when the bottom of the cake filter paper directly faces the discharge opening 221. The support piece 227 may be integrally formed with the lower cup body 22 or may be adhered to the lower cup body 22. Specifically, the four supporting pieces 227 integrally formed with the lower cup body 22 are shown in this embodiment.

A third embodiment of the present disclosure differs from the first embodiment in that:

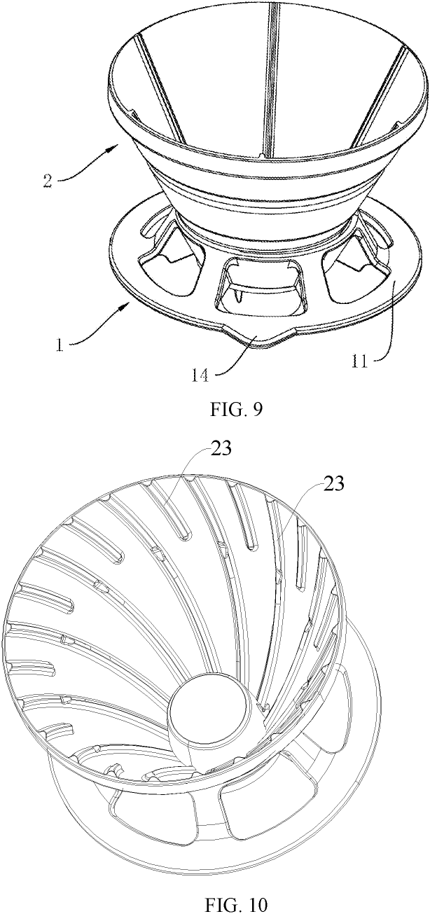

Referring to FIG. 9, a handle 14 is provided on the base 1, the handle 14 may be connected to the positioning ring 11, the support ring 12, or the connecting strips 13, and the shape of the handle 14 may be adjusted according to design requirements. Through the arrangement of the handle 14, the coffee lover is not easy to stick to the coffee liquid or condensed water on the base 1 or the foldable cup body 2 when taking the coffee filter cup, thereby improving the user experience. In this embodiment, the handle 14 is disposed at the edge of the positioning ring 11, so as to facilitate the coffee lover to pick up the coffee filter cup.

All the above are preferred embodiments of the present disclosure, and the scope of protection of the present disclosure is not limited thereto, and therefore, the equivalent changes made according to the structure, shape and principle of the present disclosure shall fall within the scope of protection of the present disclosure.

What is claimed is:

1. A coffee filter cup, comprising: a base and a foldable cup body, wherein the foldable cup body is disposed on the base, the base is provided with a mounting hole for the foldable cup body to penetrate through, and a bottom of the foldable cup body is provided with a discharge opening; the foldable cup body comprises an upper cup body and a lower cup body connected in sequence; a connection position between the lower cup body and the upper cup body is provided with a first crease groove, and the first crease groove extends along a circumferential direction of the lower cup body; and the lower cup body is capable of being folded towards an inside of the upper cup body through the first crease groove to form a support table.

2. The coffee filter cup according to claim 1, wherein the upper cup body is provided with a protruding ring, and the protruding ring passes through the mounting hole and is positioned at a bottom of the base.

3. The coffee filter cup according to claim 1, wherein at least one liquid drainage hole is provided on at least one of a bottom of the upper cup body and a top of the lower cup body.

4. The coffee filter cup according to claim 1, wherein the upper cup body is provided with at least two second crease grooves, and each of the at least two second crease grooves extends along a circumferential direction of the upper cup body.

5. The coffee filter cup according to claim 1, wherein a plurality of ribs are disposed on an inner wall of the foldable cup body at intervals.

6. The coffee filter cup according to claim 1, wherein a top of the upper cup body is provided with a reinforcing ring.

7. The coffee filter cup according to claim 1, wherein at least two limiting blocks are uniformly provided on a bottom surface of the base, and the at least two limiting blocks are configured to be inserted into a coffee pot and/or a coffee cup.

8. The coffee filter cup according to claim 7, wherein the base comprises a positioning ring, a support ring and a plurality of connecting strips; the support ring is disposed on an inside of the positioning ring, and the plurality of connecting strips are arranged at an interval and are connected between the support ring and the positioning ring; the positioning ring is positioned at an opening of the coffee pot and/or an opening of the coffee cup, the mounting hole is provided on the support ring, and the at least two limiting blocks are arranged at bottoms of the plurality of connecting strips.

9. The coffee filter cup according to claim 8, wherein a connection position between each of the plurality of connecting strips and the support ring is located above a connection position between each of the plurality of connecting strips and the positioning ring.

10. The coffee filter cup according to claim 1, wherein the base is provided with a handle.
